(19) United States
(12) Patent Application Publication
(10) Pub. No.: US 2026/0368262 A1
(43) Pub. Date: Nov. 19, 2026

(54) SYSTEMS AND METHODS FOR STRUCTURED BAYESIAN CLASSIFICATION FOR CONTENT MANAGEMENT

(71) Applicant: Micro Focus LLC, Santa Clara, CA (US)

(72) Inventors: Sean Blanchflower, Cambridge (GB); Chris Smith, Cambridge (GB)

(21) Appl. No.: 19/672,168

(22) Filed: May 8, 2026

Related U.S. Application Data
(63) Continuation of application No. 18/486,916, filed on Oct. 13, 2023, now abandoned.

(51) Int. Cl. G06F 16/906; G06F 16/908

(52) U.S. Cl. CPC G06F 16/906; G06F 16/908

(57) ABSTRACT

A system includes a processor and a memory. When executed by the processor, the processor is caused to receive a document including at least one of structured data, semi-structured data, and unstructured data, analyze the metadata in the structured format to generate features enhancing the metadata in the structured format, produce classification data for the document based on the features enhancing the metadata in the structured format and the content in the unstructured format, automatically classify the document based on the classification data and store the classification data in a database structure. The classification data is used to effectively search for the document. The structured data includes metadata about the document in a structured format, the semi-structured data includes content of the document in an unstructured format and metadata about the document in the structured format and the unstructured data includes the content of the document in the unstructured format.

### CROSS REFERENCE TO RELATED APPLICATION

The present application is a continuation of U.S. Patent Application No. 18/486,916, filed Oct. 13, 2023, entitled "SYSTEMS AND METHODS FOR STRUCTURED BAYESIAN CLASSIFICATION FOR CONTENT MANAGEMENT", which is incorporated herein by this reference in its entirety.

### FIELD

The present disclosure relates generally to systems and methods for document processing and information extraction and more particularly to systems and methods for document processing and information extraction for efficiently classifying structured, semi-structured and unstructured data based on feature enhancement.

### BACKGROUND

The field of document classification is a well-explored one. A large variety of solutions exist for achieving the classification of documents. Most of these solutions, however, concentrate on the “unstructured data” or free text of the content provided in a document for classification purposes. Other solutions focus on the metadata fields of a document, but again these solutions tend to simply apply the same analysis to values associated with the metadata fields in the same manner as that performed on the content provided in the document. Currently, content management requires the classification of documents based entirely on the “structured” metadata fields associated with the documents. Moreover, in many cases a document may not contain any free text (e.g., a picture or image document) and content management is thus left to classify the document based on the structured metadata associated with the document that contains no free text. Therefore, there is a need for systems and methods for the classification of structured or semi-structured documents in an efficient manner.

### SUMMARY

Embodiments of the present disclosure provide systems, methods and non-transitory computer-readable mediums for document processing and information extraction for efficiently classifying structured, semi-structured and unstructured data based on feature enhancement. According to one embodiment of the present disclosure, a system includes a processor and a memory coupled with and readable by the processor and storing therein a set of instructions. When executed by the processor, the processor is caused to receive a document including at least one of structured data, semi-structured data, and unstructured data. The structured data includes metadata about the document in a structured format, the semi-structured data includes content of the document in an unstructured format and metadata about the document in the structured format and the unstructured data includes the content of the document in the unstructured format.

The processor is further caused to analyze the metadata in the structured format to generate features enhancing the metadata in the structured format, produce classification data for the document based on the features enhancing the metadata in the structured format and the content in the unstructured format, automatically classifying the document based on the classification data and store the classification data in a database structure. The classification data is used to effectively search for the document.

Aspects of the above system include wherein the features enhancing the metadata include fields, values, and combinations of the fields and the values evaluated from the metadata.

Aspects of the above system include wherein the features enhancing the metadata are evaluated from the metadata based on a continuum of a numerical value of a field in the metadata instead of the numerical value of the field itself.

Aspects of the above system include wherein the features enhancing the metadata are evaluated from the metadata based on a proximity of each of the features enhancing the metadata to other features enhancing the metadata.

Aspects of the above system include wherein the features enhancing the metadata are evaluated from the metadata based on weights assigned to each of the features enhancing the metadata.

Aspects of the above system include wherein the instructions, when executed by the processor, cause the processor to combine the classification data for a plurality of documents into a category and train the category.

Aspects of the above system include wherein the content in the unstructured format includes one of natural language data, speech data, audio data still image data, web page data, and video data.

Aspects of the above system include wherein the fields include at least one of a location of the document, a type of document and an author of the document.

Aspects of the above system include wherein the instructions, when executed by the processor, cause the processor to assign a priority value to the features enhancing the metadata.

Aspects of the above system include wherein the instructions, when executed by the processor, cause the processor to create a plurality of agents, wherein each agent of the plurality of agents is created for each category for a plurality of categories and compare one agent of the plurality of agents to one or more other agents of the plurality of agents to determine an overall mapping of the plurality of categories.

Aspects of the above system include wherein the instructions, when executed by the processor, cause the processor to compare a new document to the plurality of agents, determine if the new document matches one or more of the categories represented by the plurality of agents and if the new document does not match one or more of the categories represented by the plurality of agents, create a new agent for a new category represented by the new document

Aspects of the above system include wherein the instructions, when executed by the processor, cause the processor to compare one agent of the plurality of agents to a plurality of new documents and determine which new documents of the plurality of new documents best match the category represented by the one agent.

According to one embodiment of the present disclosure, a method includes receiving, by a processor, a document including at least one of structured data, semi-structured data, and unstructured data, analyzing, by the processor, the metadata in the structured format to generate features enhancing the metadata in the structured format, producing, by the processor, classification data for the document based on the features enhancing the metadata in the structured format and the content in the unstructured format, automatically classifying, by the processor, the document based on the classification data and storing, by the processor, the classification data in a database structure. The structured data includes metadata about the document in a structured format, the semi-structured data includes content of the document in an unstructured format and metadata about the document in the structured format and the unstructured data includes the content of the document in the unstructured format. Moreover, the classification data is used to effectively search for the document.

Aspects of the above method include wherein the features enhancing the metadata include fields, values, and combinations of the fields and the values evaluated from the metadata.

Aspects of the above method include wherein the features enhancing the metadata are evaluated from the metadata based on a continuum of a numerical value of a field in the metadata instead of the numerical value of the field itself.

Aspects of the above method include wherein the features enhancing the metadata are evaluated from the metadata based on a proximity of each of the features enhancing the metadata to other features enhancing the metadata.

Aspects of the above method include wherein the features enhancing the metadata are evaluated from the metadata based on weights assigned to each of the features enhancing the metadata.

According to one embodiment of the present disclosure, a non-transitory, computer-readable medium includes a set of instructions stored therein which when executed by a processor, causes the processor to receive a document including at least one of structured data, semi-structured data, and unstructured data, analyze the metadata in the structured format to generate features enhancing the metadata in the structured format, produce classification data for the document based on the features enhancing the metadata in the structured format and the content in the unstructured format, automatically classify the document based on the classification data and store the classification data in a database structure. The structured data includes metadata about the document in a structured format, the semi-structured data includes content of the document in an unstructured format and metadata about the document in the structured format and the unstructured data includes the content of the document in the unstructured format. Moreover, the classification data is used to effectively search for the document.

Aspects of the above non-transitory, computer readable medium include wherein the features enhancing the metadata include fields, values, and combinations of the fields and the values evaluated from the metadata.

Aspects of the above non-transitory, computer readable medium include wherein the features enhancing the metadata are evaluated from the metadata based on a continuum of a numerical value of a field in the metadata instead of the numerical value of the field itself.

These and other needs are addressed by the various embodiments and configurations of the present disclosure. The present disclosure can provide a number of advantages depending on the particular configuration. These and other advantages will be apparent from the disclosure contained herein.

Embodiments of the present disclosure provide a number of advantages over conventional classification systems for documents in a database structure. As discussed above, the traditional classification systems for documents in a database structure generally apply the same analysis on the values of the metadata fields as is performed on the content. By efficiently classifying structured, semi-structured and unstructured data based on feature enhancement, the overall size of the database structure is dramatically reduced in comparison to traditional database structures. This results in a much more efficient database structure that can support irrelevant data being removed while relevant data is retained than was previously possible using the same hardware.

Because embodiments of the present disclosure can support irrelevant data being removed while relevant data is retained using the same hardware, this allows embodiments of the present disclosure to support a higher number of transactions more efficiently and at lower cost. The described embodiments of the present disclosure make the existing hardware more efficient while reducing the overall cost to data classification on a large scale which was previously impossible.

In addition, systems and methods for document processing and information extraction for efficiently classifying structured, semi-structured and unstructured data based on feature enhancement described herein are designed to support document retrieval based on classification data in real-time. Being able to support document retrieval based on classification data in real-time is clearly something that cannot be done practically using a mental process. Instead, document retrieval based on classification data in real-time described herein will only work practically in a computerized environment.

Being able to support a higher number of document searches based on classification data more efficiently and at a lower cost cannot be performed manually and in real-time. For example, being able to support a higher number of document searches based on classification data more efficiently and at a lower cost involves managing terra bytes of information from a very large number of devices to identify issues from a very large number of users in real-time (e.g., thousands of users). Being able to support a higher number of document searches based on classification data more efficiently and at a lower cost would simply take too long if performed using a pen and paper.

Some implementations of the present disclosure described herein may realize, in certain instances, one or more of the following advantages. A system implementing efficiently classifying structured, semi-structured and unstructured data based on feature enhancement may improve the rate at which documents may be taken in and processed compared to systems that do not implement efficiently classifying structured, semi-structured and unstructured data based on feature enhancement, thus improving process efficiency. Furthermore, a system implementing efficiently classifying structured, semi-structured and unstructured data based on feature enhancement may incur a reduced number of errors, e.g., human errors, and an increase in document classification accuracy when processing and classifying documents compared to other systems that do not implement efficiently classifying structured, semi-structured and unstructured data based on feature enhancement.

A system implementing efficiently classifying structured, semi-structured and unstructured data based on feature enhancement may be trained using training data for specific classification tasks, e.g., those relevant to a particular business or department, and may continuously learn over time to improve its accuracy and reliability, for example by exposing the system to an increased amount or types of training data.

By organizing and using the features enhancing the metadata in this manner, the size of the metadata for the database structure may be significantly reduced due to redundant information and indexing-related information are correspondingly reduced.

The details of one or more embodiments of the subject matter described in this specification are set forth in the accompanying drawings and the description below. Other potential features, aspects, and advantages of the subject matter will become apparent from the description, the drawings, and the claims.

The phrases “at least one”, “one or more”, “or”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C”, “A, B, and/or C”, and “A, B, or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Any combination of one or more computer readable medium(s) may be utilized. The computer readable medium may be a computer readable signal medium or a computer readable storage medium.

A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device. For example, the computer readable medium (s) may be non-transitory or non-volatile medium, such as a magnetic disk or solid-state non-volatile memory or volatile medium such as RAM.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine”, “calculate” and “compute,” and variations thereof, as used herein, are used interchangeably and include any type of methodology, process, mathematical operation or technique.

The term “means” as used herein shall be given its broadest possible interpretation in accordance with 35 U.S.C., Section 112(f) and/or Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

FIG. 1 is a block diagram illustrating elements of an example computing environment in which embodiments of the present disclosure may be implemented.

FIG. 2 is a block diagram illustrating elements of an example computing system in which embodiments of the present disclosure may be implemented.

FIG. 3 is a block diagram illustrating elements of an example system for classifying and searching for documents in which embodiments of the present disclosure may be implemented.

FIG. 4 is a block diagram illustrating the various components of a classification service, for classifying documents in which embodiments of the present disclosure may be implemented.

FIG. 5 is a flowchart illustrating an example method for document processing and information extraction for efficiently classifying structured, semi-structured and unstructured data based on feature enhancement according to an embodiment of the present disclosure.

FIG. 6 is a flowchart illustrating an example method for generating a mapping of all categories represented by a plurality of agents according to an embodiment of the present disclosure.

FIG. 7 is a flowchart illustrating an example method for mapping a document to a plurality of agents according to an embodiment of the present disclosure.

FIG. 8 is a flowchart illustrating an example method for mapping one agent of a plurality of agents to a plurality of new documents according to an embodiment of the present disclosure.

In the appended figures, similar components and/or features may have the same reference label. Further, various components of the same type may be distinguished by following the reference label by a letter that distinguishes among the similar components. If only the first reference label is used in the specification, the description is applicable to any one of the similar components having the same first reference label irrespective of the second reference label.

### DETAILED DESCRIPTION

Embodiments of the present disclosure are directed to systems and methods for document processing and information extraction for efficiently classifying structured, semi-structured and unstructured data based on feature enhancement. Features are determined from structure metadata. According to embodiments of the present disclosure, systems and methods are provided in which the full structure of a document is considered when classification training takes place. According to such systems and methods, document information arranged in a structured format is further considered. As such, the fields and the values associated with the fields of the document information are abstracted so that the analysis of this information uses more generalized features than simply the “bag of words” models that pervade the classification discipline. For example, systems and methods can use the mere presence of a field (e.g., field name) as a feature generated for enhanced classification. Moreover, systems and methods may treat the combination of the field name and the field value as a feature for enhanced classification. Furthermore, fields containing numeric value are treated abstractly, with the feature mapping to a continuum, rather than just a single value. In this way, all features can be compared so that the proximity of features can be easily evaluated as opposed to simply determining whether a feature is identical to another feature. According to further embodiments of the present disclosure, the generated features may be weighted using methods of statistic influence such as Bayesian analysis for example, of the corpus as a whole, allowing for the distinctiveness of key or important features to be generated or to be established.

Following the training of categories associated with evaluated documents, the set of all features for a single category are combined to form an agent. Any category agent can then be compared to any other category agent to give an overall mapping of all of the categories represented by agents. A category agent can also be created for any single document. According to an embodiment of the present disclosure, a document is compared to the existing set of category agents in order to determine the category agent or category agents to which the document should be placed. According to a further embodiment of the present disclosure, a category agent can be compared against a corpus of previously unseen documents to find the documents most relevant to that category agent.

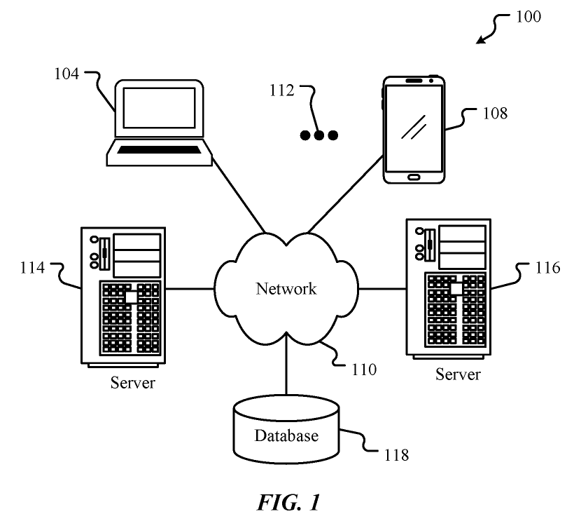

FIG. 1 is a block diagram illustrating elements of an example computing environment 100 in which embodiments of the present disclosure may be implemented. More specifically, this example illustrates a computing environment 100 that may function as the servers, user computers, or other systems provided and described herein. The environment 100 includes one or more user computers, or computing devices, such as a computer 104, a communication device 108, and/or more devices 112. The devices 104, 108, 112 may include general purpose personal computers (including, merely by way of example, personal computers, and/or laptop computers running various versions of Microsoft Corp.’s Windows® and/or Apple Corp.’s Macintosh® operating systems) and/or workstation computers running any of a variety of commercially-available UNIX® or UNIX-like operating systems. These devices 104, 108, 112 may also have any of a variety of applications, including for example, database client and/or server applications, and web browser applications. Alternatively, the devices 104, 108, 112 may be any other electronic device, such as a thin-client computer, Internet-enabled mobile telephone, and/or personal digital assistant, capable of communicating via a network 110 and/or playing audio, displaying images, etc. Although the example computer environment 100 is shown with two devices, any number of user computers or computing devices may be supported.

Environment 100 further includes a network 110. The network 110 may can be any type of network familiar to those skilled in the art that can support data communications using any of a variety of commercially-available protocols, including without limitation Session Initiation Protocol (SIP), Transmission Control Protocol/Internet Protocol (TCP/IP), Systems Network Architecture (SNA), Internetwork Packet Exchange (IPX), AppleTalk, and the like. Merely by way of example, the network 110 maybe a Local Area Network (LAN), such as an Ethernet network, a Token-Ring network and/or the like; a wide-area network; a virtual network, including without limitation a Virtual Private Network (VPN); the Internet; an intranet; an extranet; a Public Switched Telephone Network (PSTN); an infra-red network; a wireless network (e.g., a network operating under any of the IEEE 802.9 suite of protocols, the Bluetooth® protocol known in the art, and/or any other wireless protocol); and/or any combination of these and/or other networks.

The environment 100 may also include one or more servers 114, 116. For example, the servers 114, 116 may comprise build servers, which may be used to test webpage layouts on various screen sizes via the device 104, 108, 112. The servers 114, 116 can be running an operating system including any of those discussed above, as well as any commercially available server operating systems. The servers 114, 116 may also include one or more files and/or application servers, which can, in addition to an operating system, include one or more applications accessible by a client running on one or more of the devices 104, 108, 112. The server(s) 114 and/or 116 may be one or more general purpose computers capable of executing programs or scripts in response to the computers 104, 108, 112. As one example, the servers 114 and 116, may execute one or more automated tests. The automated tests may be implemented as one or more scripts or programs written in any programming language, such as Java^{TM}, C, C#®, or C++, and/or any scripting language, such as Perl, Python, or Tool Command Language (TCL), as well as combinations of any programming/scripting languages. The server(s) 114 and 116 may also include database servers, including without limitation those commercially available from Oracle®, Microsoft®, Sybase®, IBM® and the like, which can process requests from database clients running on the device 104, 108, 112.

The tests created and/or initiated by the device 104, 108, 112 (including tests created by other devices not illustrated) are shared to the server 114 and/or 116, which then may test and/or deploy the websites/webpages. The server 114 and/or 116 may transfer the generated webpage layout and/or data related to the same to the device 104, 108, 112. Although for ease of description, FIG. 1 illustrates two servers 114 and 116, those skilled in the art will recognize that the functions described with respect to servers 114, 116 may be performed by a single server and/or a plurality of specialized servers, depending on implementation-specific needs and parameters. The computer systems 104, 108, 112, and servers 114, 116 may function as the system, devices, or components described herein.

The environment 100 may also include a database 118. The database 118 may reside in a variety of locations. By way of example, database 118 may reside on a storage medium local to (and/or resident in) one or more of the computers/servers 104, 108, 112, 114, 116. Alternatively, the database 118 may be remote from any or all of the computers/servers 104, 108, 112, 114, 116, and in communication (e.g., via the network 110) with one or more of these. The database 118 may reside in a Storage-Area Network (SAN) familiar to those skilled in the art. Similarly, any necessary files for performing the functions attributed to the computers/servers 104, 108, 112, 114, 116 may be stored locally on the respective computer/server and/or remotely, as appropriate. The database 118 may be used to store webpage layout data (e.g., respective locations of a plurality of elements), alerts, etc.

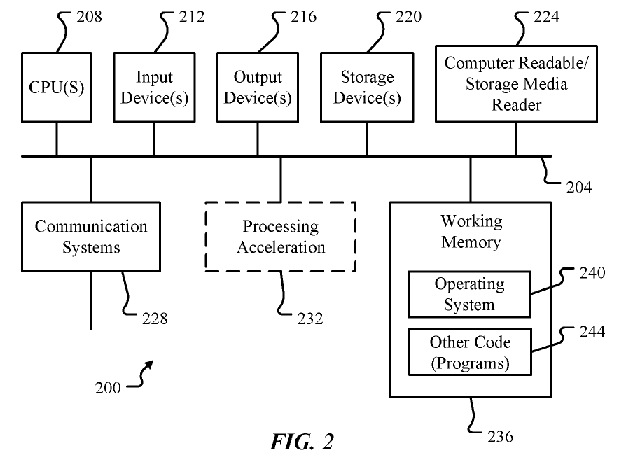

FIG. 2 is a block diagram illustrating elements of an example computing system 200 in which embodiments of the present disclosure may be implemented. More specifically, this example illustrates one embodiment of a computer system 200 upon which the servers, computing devices, or other systems or components described above may be deployed or executed. The computer system 200 is shown comprising hardware elements that may be electrically coupled via a bus 204. The hardware elements may include one or more Central Processing Units (CPUs) 208; one or more input devices 212 (e.g., a mouse, a keyboard, etc.); and one or more output devices 216 (e.g., a display device, a printer, etc.). The computer system 200 may also include one or more storage devices 220. By way of example, storage device(s) 220 may be disk drives, optical storage devices, solid-state storage devices such as a Random-Access Memory (RAM) and/or a Read-Only Memory (ROM), which can be programmable, flash-updateable and/or the like.

The computer system 200 may additionally include a computer-readable storage media reader 224; a communications system 228 (e.g., a modem, a network card (wireless or wired), an infra-red communication device, etc.); and working memory 236, which may include RAM and ROM devices as described above. The computer system 200 may also include a processing acceleration unit 232, which can include a Digital Signal Processor (DSP), a special-purpose processor, and/or the like.

The computer-readable storage media reader 224 can further be connected to a computer-readable storage medium, together (and, optionally, in combination with storage device(s) 220) comprehensively representing remote, local, fixed, and/or removable storage devices plus storage media for temporarily and/or more permanently containing computer-readable information. The communications system 228 may permit data to be exchanged with a network and/or any other computer described above with respect to the computer environments described herein. Moreover, as disclosed herein, the term “storage medium” may represent one or more devices for storing data, including ROM, RAM, magnetic RAM, core memory, magnetic disk storage mediums, optical storage mediums, flash memory devices and/or other machine-readable mediums for storing information.

The computer system 200 may also comprise software elements, shown as being currently located within a working memory 236, including an operating system 240 and/or other code 244. It should be appreciated that alternate embodiments of a computer system 200 may have numerous variations from that described above. For example, customized hardware might also be used and/or particular elements might be implemented in hardware, software (including portable software, such as applets), or both. Further, connection to other computers such as network input/output devices may be employed.

Examples of the processors 208 as described herein may include, but are not limited to, at least one of Qualcomm® Snapdragon® 800 and 801, Qualcomm® Snapdragon® 620 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

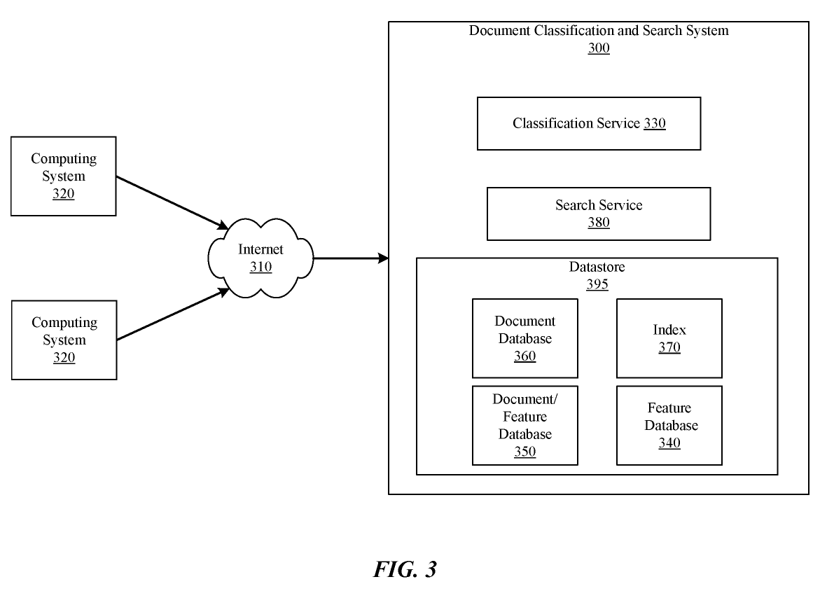

FIG. 3 is a block diagram illustrating elements of an example system 300 for classifying and searching for documents in which embodiments of the present disclosure may be implemented. As used herein, a document is defined as a physical document or an electronic document such as a media resource that can be electronically stored and that contains images or sound, either separately (e.g., photos, slideshows, silent films or audio recordings), combined (e.g., videos or animation), or in conjunction with other content (e.g., presentations with text, multimedia presentations). The classification and search system 300 is capable of automatically classifying documents using features enhanced from structured metadata and enabling access to the documents via keyword search or keyword navigation. The document classification and search system 300 is connected via a communication medium, for example the Internet 310, a proprietary network, or other communication connection, to a number of remote computing systems 320. The metadata associated with documents is received by the system via the communication medium and is processed by a classification service 330.

The received metadata may be structured, unstructured, or a combination of the two (i.e., semi-structured). Structured metadata is metadata that has a known identity or format, for example, a portion of the metadata that describes the author of the document. Unstructured metadata is metadata that contains information of an unknown identity or unknown format. Classification service 330 associates one or more features enhanced from the structured metadata of the corresponding document. The underlying document or a pointer to the location where the document is stored (such as a network path) may be stored in a document database 360. Once documents are associated with features, the system 300 may generate a reverse index 370. The index 370 allows documents to be identified that are responsive to search terms contained in search queries. Those skilled in the art will appreciate that many different types of indices may be generated, depending on performance and other considerations. Feature database 340, document/feature database 350, document database 360, and index 370 are all identified as part of a general database structure 395.

Those skilled in the art will appreciate that the actual implementation of the data storage area 395 may take a variety of forms, including storage in a computer-readable medium, and the term “database” is used in the generic sense to refer to any data structure that allows data to be stored and accessed, such as tables, linked lists, arrays, etc.

When a search is to be performed to locate a particular document or category of document, a search service 380 receives the search query or search request and applies the search terms contained in the query against index 370. The search query may include both a text query and other information that further defines the parameters of the search. The index 370 is used to identify documents in the document database 360 that are responsive to the search query. Those skilled in the art will appreciate that standard search techniques may be used to pre-process the search query, as well as to post-process and prioritize the resulting search results that are responsive to the query. Those skilled in the art will also appreciate that some or all of the keywords (e.g., the features enhancing structured metadata and/or classification data) be used in a browser hierarchy to allow users to navigate to desired documents. In some applications, the features may also be displayed in conjunction with documents to further characterize the documents. The use of features enhancing structured metadata greatly increases the speed and likelihood that users submitting search queries or browsing will be able to identify one or more documents that are responsive to their search. Once the user identifies one or more documents, the displayed features may provide an improved context in which the user may utilize the documents.

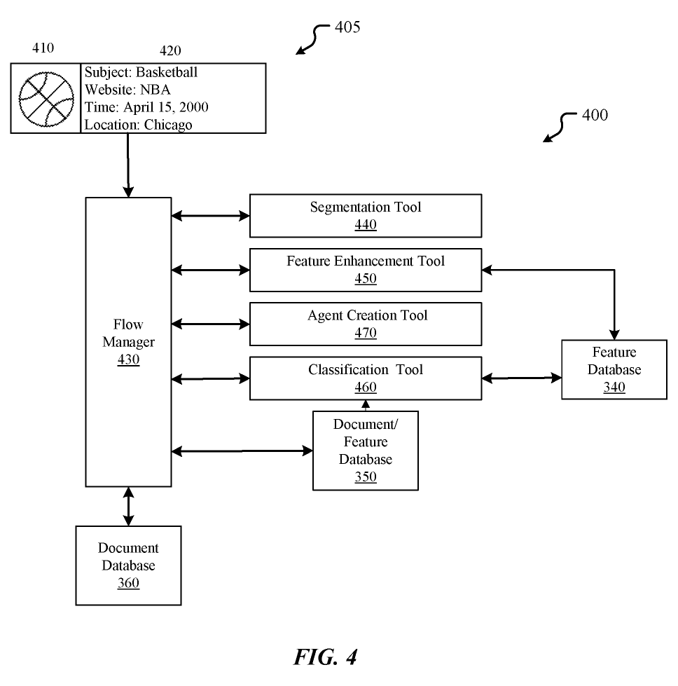

FIG. 4 is a block diagram illustrating elements of an example system 400 for analyzing structured metadata associated with a document and storing the document so that the document is accessible via a keyword index or keyword navigation in which embodiments of the present disclosure may be implemented. Moreover, FIG. 4 is a block diagram illustrating the various components of the classification service 330, which receives structured metadata associated with documents, analyzes the structured metadata to generate features enhancing the structured metadata, and automatically classify the document based on the features enhancing the metadata of the structured data.

In some embodiments of the present disclosure, the classification service receives as input document 405. Included with each document 405 is content 410 and metadata 420 that provides information about the document 405. According to an embodiment of the present disclosure, the content 410 may include one of natural language data, speech data, audio data still image data, web page data, and video data. The metadata 420 may be provided in a variety of different formats, and may contain information such as the location of the document, a type of document, an author of the document, the date of the document, the content of the document, etc. In the example depicted in FIG. 4, the content 410 is an image of a basketball or a basketball game. Metadata 420 associated with the image provides additional details about the content 410 of the document 405, specifically “Subject: Basketball, Website: NBA, Time: April 15, 2000, and Location: Chicago.” While an image of a basketball or a basketball game will be used as an example in the discussion below, it will be appreciated that the image 410 and metadata 420 is merely representative of the type of content and metadata that may be processed by the system.

The content 410 and the associated metadata 420 is received by a flow manager 430 which manages the processing of the metadata 420 through a variety of steps to be described in greater detail below. Flow manager 430 is connected to a segmentation tool 440, a feature enhancement tool 450, an agent creation tool 470 and a classification tool 460. The segmentation tool 440 separates the content 410 from the associated metadata 420 and parses the associated metadata 420 into the various field names and field values associated with the structured metadata. For example, the metadata 420 is parsed into the field names “Subject, Website, Time and Location” and into the field values “Basketball, NBA, April 15, 2000 and Chicago.”

The feature enhancement tool 450 receives as input, the field names and the field values for the structured metadata. The feature enhancement tool 450 analyzes the structured data (e.g., the field names and field values) and generates features enhancing the structured data. For example, the presence of the field value “NBA” for the field name “Website” would further confirm or provide a higher probability that the document 405 is about “basketball” even if the content (e.g., the image of a basketball game) was not available or distorted in some manner.

Moreover, in other data classification areas such as in the corporate, legal, or medical arena employing a records management system, the generation of features enhancing structured data would be most beneficial. For example, in the corporate arena, hundreds of fields and field values are associated with a single document. These fields and field values may or may not be visible. Some of the fields may be indicative of a category. Take for example, a corporation having a human resources (HR) department, a legal department and a research and development (R & D) department. A document that includes a field name “Applicant” and a field value “John Smith” among other field names and field values, may automatically be classified as an HR document as compared to a legal document or an R & D document. Thus, the presence of the field name “Applicant” may be indicative that the document is an HR document. The field value “John Smith” may not be relevant since John Smith could be the name of a client to the company or the name of an inventor for the company. Thus, the field value in this case would be irrelevant because the field value would change for each Applicant for example. Alternatively, the presence of the field name “Inventor” or “Assignee” may be indicative that a document is an R & D document or a legal document, respectively, and the field value of a person’s’ name would not necessarily be relevant.

According to an embodiment of the present disclosure, the features extracted from the structured data may be assigned a probability value indicative that the feature(s) accurately define the document. For example, given the feature of the presence of a field value “NBA” associated with a particular document, there is a 7% likelihood the document is about baseball, a 92% likelihood the document is about basketball and a 1% likelihood the document is about football. According to a further example, given the feature of the presence of a field name “Applicant” associated with a particular document, there is a 10% likelihood the document is an R & D document, an 85% likelihood the document is an HR document and a 5% likelihood the document is a legal document. According to embodiments of the present disclosure, the probability values are determined based on an evaluation of each of the field names, field values, and combinations thereof. Moreover, the probability values may be determined using the content of the document along with features from the structured data. Therefore, mixing of the structured data and the unstructured data is performed as compared to conventional techniques where these two different types of data are evaluated separately. According to embodiments of the present disclosure, the features enhancing the structured metadata are used in conjunction with unstructured data or unstructured data converted into structure data for automatically classifying data.

The flow manager 430 is also connected to the classification tool 460, the document database 360 and the document/feature database 350. When document 405 including content 410 and metadata 420 is received by the flow manager, the document 405 or a pointer to the document is stored in the document database 360 for subsequent access. The flow manager 430 ensures the orderly classification of the document by the classification tool 460 making calls to the various tools and receiving results from each of the tools when processing is complete.

According to one embodiment of the present disclosure, agent creation tool 470 creates a plurality of agents. Each agent of the plurality of agents is created for each of the trained categories for a plurality of trained categories. According to one embodiment of the present disclosure, agent creation tool 470 compares one agent of the plurality of agents to one or more other agents of the plurality of agents to determine an overall mapping of the plurality of categories. In a first example if one agent category is the “Baltimore Orioles” (an MLB baseball team) and another agent category is the “Chicago Cubs” (an MLB baseball team), then these agent categories would be considered similar to each other (e.g., they are both MLB baseball teams). Alternatively, in a second example, if one agent category is the “Chicago Bulls” (an NBA basketball team) and another agent category is the “Baltimore Ravens” (an NFL football team), then these agent categories would not be considered similar to each other (e.g., one is an NBA basketball team and the other is an NFL football team).

In another example, agent creation tool 470 could rank how similar or how dissimilar the agent categories are to each other. Using the first example above, although the two agent categories are ranked as being two MLB baseball teams, the two agent categories would be ranked differently since the agent category for the “Baltimore Orioles” is an MLB baseball team from the American League and the agent category for the “Chicago Cubs” is an MLB baseball team from the National League. Moreover, since the American League is divided among the American League East, the American League Central and the American League West and the National League is divided among the National League East, the National League Central and the National League West, various agent categories representing MLB baseball teams could be ranked and compared to each other.

According to an alternative embodiment of the present disclosure, agent creation tool 470 compares a new document (e.g., a document not used for classification training purposes) to the plurality of created agents. The comparison of the new document to the plurality of created agents is used to determine if the new document matches one or more of the categories represented by the plurality of agents. If the new document matches one or more of the categories represented by the plurality of agents, the new document is classified as belonging to the one or more categories represented by the plurality of agents. If, however, the new document does not match one or more of the categories represented by the plurality of agents, the agent creation tool 470 creates a new agent for a new category represented by the new document.

According to a further alternative embodiment of the present disclosure, agent creation tool 470 compares one agent of the plurality of agents to a plurality of new documents. The new documents are documents that were not used for classification training purposes. Agent creation tool 470 then determines which new documents of the plurality of new documents best match the category represented by the one agent. The new documents can be arranged based on the most relevant document that matches the category represented by the one agent to the least relevant document that matches the category represented by the one agent. Moreover, a percentage value can be assigned to each of the new documents based on how closely the new document matches the category represented by the one agent. For example, out of 10 new documents, 4 new documents can be assigned a value of 75% in terms of matching the category represented by the one agent, 3 new documents can be assigned a value of 50% in terms of matching the category represented by the one agent, 2 new documents can be assigned a value of 25% in terms of matching the category represented by the one agent and 1 new document can be assigned a value of 10% in terms of matching the category represented by the one agent.

According to embodiments of the present disclosure, a priority value may be assigned to the features enhancing the structured metadata.

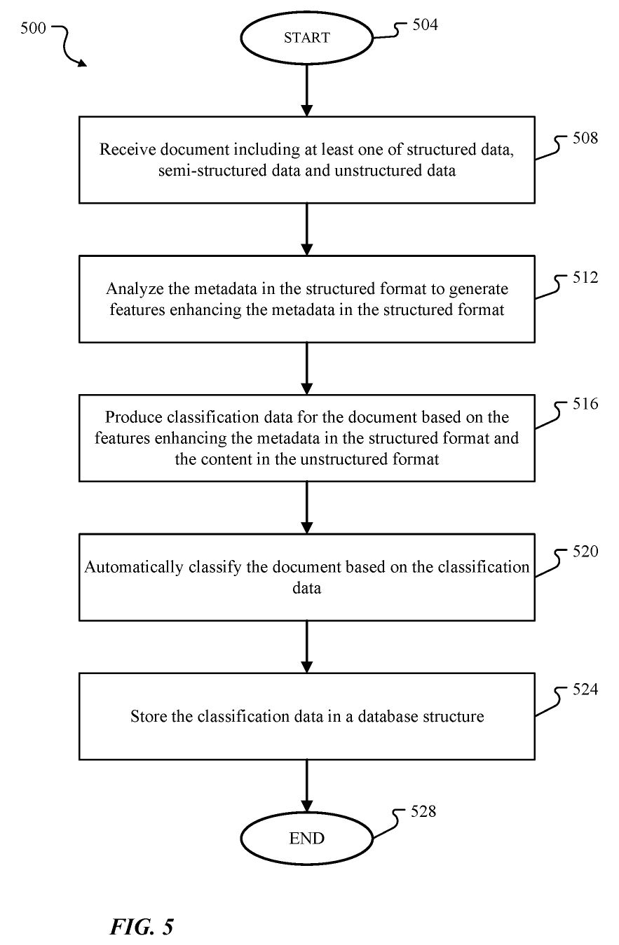

FIG. 5 is a flowchart illustrating an example method 500 for document processing and information extraction for efficiently classifying structured, semi-structured and unstructured data based on feature enhancement according to embodiments of the present disclosure. While a general order of the steps of method 500 is shown in FIG. 5, method 500 can include more or fewer steps or can arrange the order of the step differently than those shown in FIG. 5. Further, two or more steps may be combined in one step. Generally, method 500 starts with a START operation at step 504 and ends with an END operation at step 528. The method 500 can be executed as a set of computer-executable instructions executed by a computer system (e.g., processor 208, the classification service 330, etc.) and encoded or stored on a computer readable medium. Hereinafter, method 500 shall be explained with reference to the systems, components, modules, applications, software, data structures, user interfaces, etc. described in conjunction with FIGS. 1-4.

Method 500 begins with the START operation at step 504 and proceeds to step 508, where the processor 208 and/or the segmentation tool 440 receives a document including at least one of structured data, semi-structured data and unstructured data. According to an embodiment of the present disclosure, the structured data includes metadata about the document in a structured format, the semi-structured data includes content of the document in an unstructured format and metadata about the document in the structured format and the unstructured data includes the content of the document in the unstructured format. After the processor 208 and/or the segmentation tool 440 receives a document including at least one of structured data, semi-structured data and unstructured data at step 508, method 500 proceeds to step 512, where the processor 208, the segmentation tool 440 and/or the feature enhancement tool 450 analyzes the metadata in the structured format to generate features enhancing the metadata in the structured format. After the processor 208, the segmentation tool 440 and/or the feature enhancement tool 450 analyzes the metadata in the structured format to generate features enhancing the metadata in the structured format at step 512, method 500 proceeds to step 516, where the processor 208 and/or the classification tool 460 produces classification data for the document based on the features enhancing the metadata in the structured format and the content in the unstructured format. After the processor 208 and/or the classification tool 460 produces classification data for the document based on the features enhancing the metadata in the structured format and the content in the unstructured format at step 516, method 500 proceeds to step 520, where the processor 208 and/or the classification tool 460 automatically classifies the document based on the classification data. After the processor 208 and/or the classification tool 460 automatically classifies the document based on the classification data at step 520, method 500 proceeds to step 524, where the processor 208, the feature database 360, and/or the document/feature database 350 stores the classification data in a database structure. According to embodiments of the present disclosure, the classification data is used to effectively search for the document in the database structure. After the processor 208, the feature database 360, and/or the document/feature database 350 stores the classification data in a database structure at step 524, method 500 ends with the END operation at step 528.

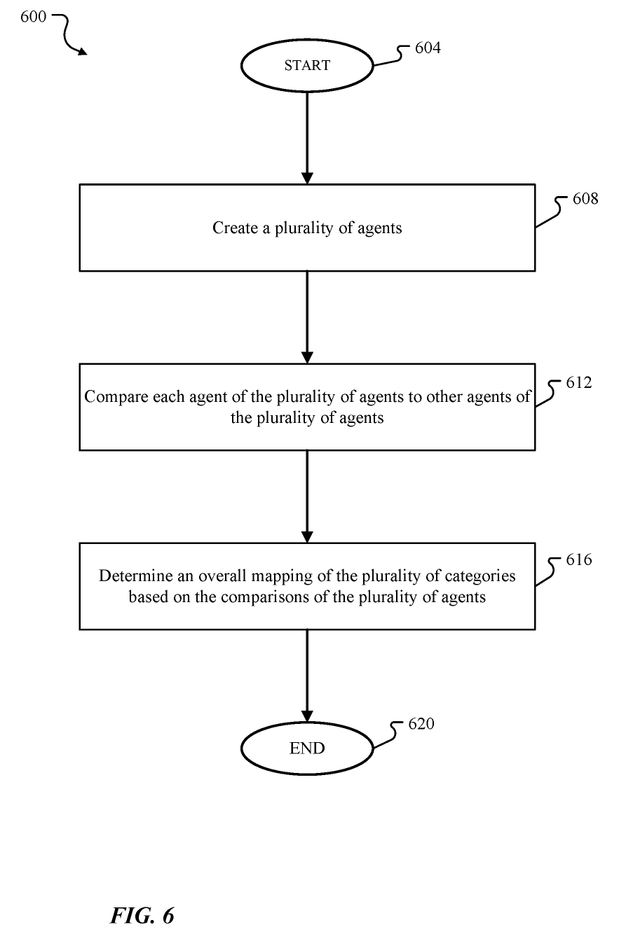

FIG. 6 is a flowchart illustrating an example method 600 for generating a mapping of all categories represented by a plurality of agents according to an embodiment of the present disclosure. While a general order of the steps of method 600 is shown in FIG. 6, method 600 can include more or fewer steps or can arrange the order of the step differently than those shown in FIG. 6. Further, two or more steps may be combined in one step. Generally, method 600 starts with a START operation at step 604 and ends with an END operation at step 620. Method 600 can be executed as a set of computer-executable instructions executed by a computer system (e.g., processor 208, the agent creation tool, etc.) and encoded or stored on a computer readable medium. Hereinafter, method 600 shall be explained with reference to the systems, components, modules, applications, software, data structures, user interfaces, etc. described in conjunction with FIGS. 1-4.

Method 600 begins with the START operation at step 604 and proceeds to step 608, where the processor 208 and/or the agent creation tool 470 creates a plurality of agents. The plurality of agents is created based on trained categories. The set of all features enhancing the metadata in the structured format and the content in the unstructured format (e.g., the classification data) for a single category are combined to form a single agent. After the processor 208 and/or the agent creation tool 470 creates a plurality of agents at step 608, method 600 proceeds to step 612, where the processor 208 and/or the agent creation tool 470 compares each agent of the plurality of agents to the other agents of the plurality of agents. After the processor 208 and/or the agent creation tool 470 compares each agent of the plurality of agents to the other agents of the plurality of agents at step 612, method 600 proceeds to step 616, where the processor 208 and/or the agent creation tool 470 determines an overall mapping of the plurality of categories based on the comparisons of the plurality of agents. After the processor 208 and/or the agent creation tool 470 determines an overall mapping of the plurality of categories based on the comparisons of the plurality of agents at step 616, method 600 ends with the END operation at step 620.

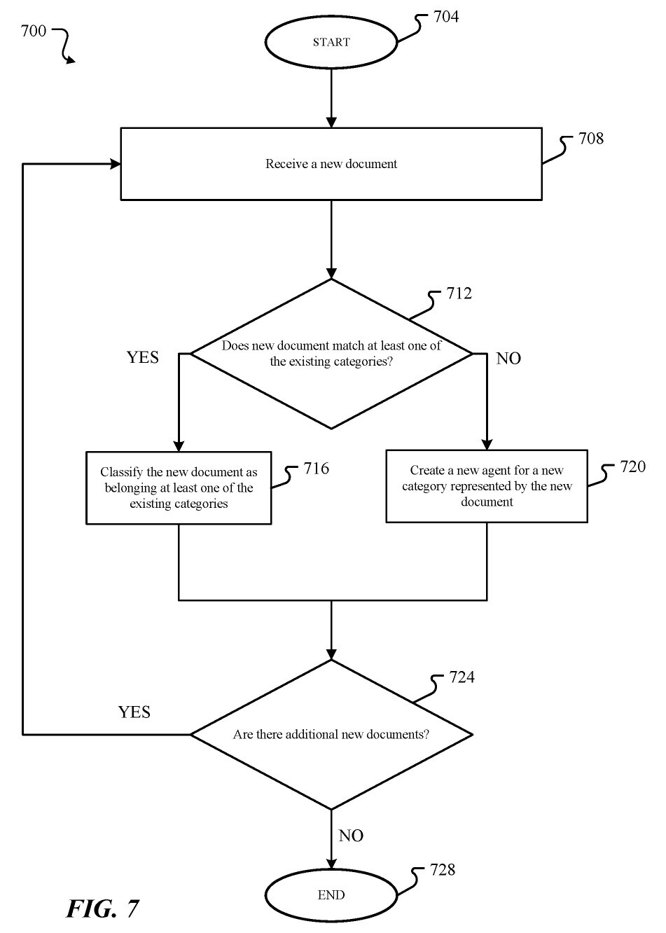

FIG. 7 is a flowchart illustrating an example method 700 for mapping a document to a plurality of agents according to an embodiment of the present disclosure. While a general order of the steps of method 700 is shown in FIG. 7, method 700 can include more or fewer steps or can arrange the order of the step differently than those shown in FIG. 7. Further, two or more steps may be combined in one step. Generally, method 700 starts with a START operation at step 704 and ends with an END operation at step 728. Method 700 can be executed as a set of computer-executable instructions executed by a computer system (e.g., processor 208, the agent creation tool, etc.) and encoded or stored on a computer readable medium. Hereinafter, method 700 shall be explained with reference to the systems, components, modules, applications, software, data structures, user interfaces, etc. described in conjunction with FIGS. 1-4.

Method 700 begins with the START operation at step 704 and proceeds to step 708, where the processor 208 and/or the agent creation tool 470 receives a new document. After the processor 208 and/or the agent creation tool 470 receives a new document at step 708, method 700 proceeds to decision step 712, where the processor 208 and/or the agent creation tool 470 determines if the new document matches at least one existing category. If the new document matches at least one existing category (YES) at decision step 712, method 700 proceeds to step 716, where the processor 208 and/or the agent creation tool 470 classifies the new document as belonging to at least one of the existing categories. If the new document does not match at least one existing category (NO) at decision step 712, method 700 proceeds to step 720, where the processor 208 and/or the agent creation tool 470 creates a new agent for a new category represented by the new document. According to an embodiment of the present disclosure, an agent can be created for any single document. After the processor 208 and/or the agent creation tool 470 classifies the new document as belonging to at least one of the existing categories at step 712 or creates a new agent for a new category represented by the new document at step 720, method 700 proceeds to decision step 724 where the processor 208 and/or the agent creation tool 470 determines if there are additional new documents. If there are additional new documents (YES) at decision step 724, method 700 returns to step 708, where the processor 208 and/or the agent creation tool 470 receives another new document. If there are no additional new documents (NO) at decision step 724, method 700 ends with the END operation at step 728.

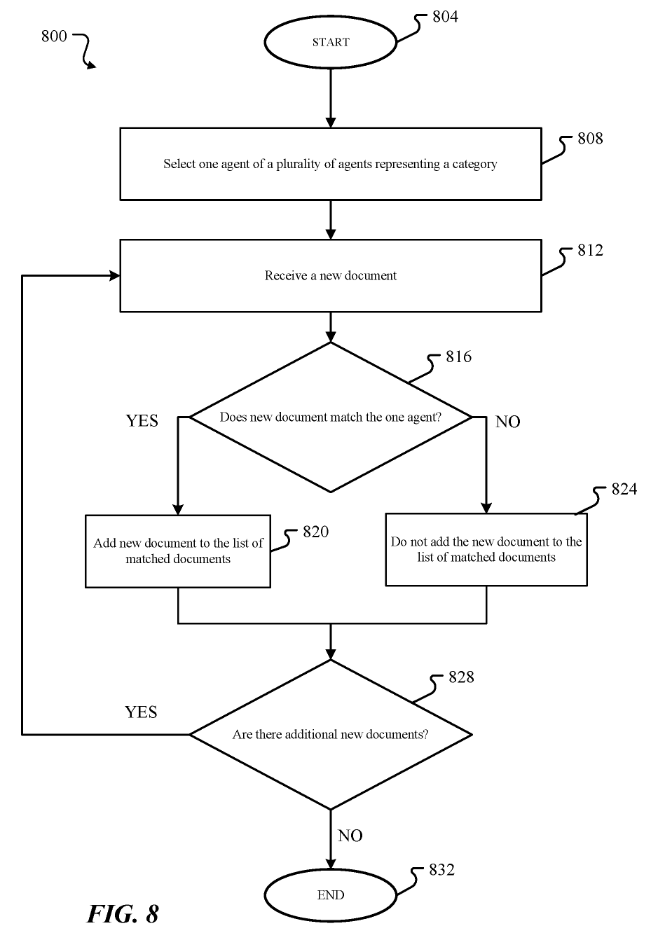

FIG. 8 is a flowchart illustrating an example method 800 for mapping one agent of a plurality of agents to a plurality of new documents according to an embodiment of the present disclosure. While a general order of the steps of method 800 is shown in FIG. 8, method 800 can include more or fewer steps or can arrange the order of the step differently than those shown in FIG. 8. Further, two or more steps may be combined in one step. Generally, method 800 starts with a START operation at step 804 and ends with an END operation at step 832. Method 800 can be executed as a set of computer-executable instructions executed by a computer system (e.g., processor 208, the agent creation tool, etc.) and encoded or stored on a computer readable medium. Hereinafter, method 800 shall be explained with reference to the systems, components, modules, applications, software, data structures, user interfaces, etc. described in conjunction with FIGS. 1-4.

Method 800 begins with the START operation at step 804 and proceeds to step 808, where the processor 208 and/or the agent creation tool 470 selects one agent of a plurality of agents representing a category. After the processor 208 and/or the agent creation tool 470 selects one agent of a plurality of agents representing a category at step 808, method 800 proceeds to step 812, where the processor 208 and/or the agent creation tool 470 receives a new document. After the processor 208 and/or the agent creation tool 470 receives a new document at step 812, method 800 proceeds to decision step 816, where the processor 208 and/or the agent creation tool 470 determines if the new document matches the one agent representing a category. If the new document matches the one agent representing a category (YES) at decision step 816, method 800 proceeds to step 820, where the processor 208 and/or the agent creation tool 470 adds the new document to a list of matched documents. If the new document does not match the one agent representing a category (NO) at decision step 816, method 800 proceeds to step 824, where the processor 208 and/or the agent creation tool 470 does not add the new document to the list of matched documents. After the processor 208 and/or the agent creation tool 470 adds the new document to a list of matched documents at step 820 or does not add the new document to the list of matched documents at step 824, method 800 proceeds to decision step 828 where the processor 208 and/or the agent creation tool 470 determines if there are additional new documents. If there are additional new documents (YES) at decision step 828, method 800 returns to step 812, where the processor 208 and/or the agent creation tool 470 receives another new document. If there are no additional new documents (NO) at decision step 828, method 800 ends with the END operation at step 832.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22nm Haswell, Intel® Core® i5-3570K 22nm Ivy Bridge, the AMD® FX™ family of processors, AMD® FX-4300, FX-6300, and FX-8350 32nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific details set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments , configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A system, comprising:
a processor; and
a memory coupled with and readable by the processor and storing therein a set of instructions which, when executed by the processor, causes the processor to:
receive a document including at least one of structured data, semi-structured data, and unstructured data,
wherein the structured data includes metadata about the document in a structured format, the semi-structured data includes content of the document in an unstructured format and metadata about the document in the structured format and the unstructured data includes the content of the document in the unstructured format and
wherein the content in the unstructured format includes one of natural language data and speech data;
receive a trained machine learning agent that is configured to predict a category for classification data for a plurality of documents,
wherein the trained machine learning agent having been trained with training data including features enhancing the metadata in the structured format and the content in the unstructured format, and
wherein during training, the trained machine learning agent learns a set of parameters configured to discriminate among a plurality of categories;
analyze the metadata in the structured format to generate features enhancing the metadata in the structured format,
wherein the features enhancing the metadata include a field, a value, and a combination of the field and the value evaluated to determine a probability value for each of the field, the value, and the combination of the field and the value for accurately defining the document;
produce the classification data for the document based on the features enhancing the metadata in the structured format and the content in the unstructured format;
provide the classification data to the trained machine learning agent, wherein the trained machine learning agent applies a transformation using learned parameter values to generate one or more predicted categories for the document; and
automatically classify the document by associating the document with the predicted category and store a classification record in memory.

2. The system of claim 1, wherein the content of the document in the unstructured format is used in determining the probability value.

3. The system of claim 1, wherein the features enhancing the metadata are evaluated from the metadata based on a continuum of a numerical value of the field in the metadata instead of the numerical value of the field itself.

4. The system of claim 1, wherein the features enhancing the metadata are evaluated from the metadata based on a proximity of each of the features enhancing the metadata to other features enhancing the metadata.

5. The system of claim 1, wherein the features enhancing the metadata are evaluated from the metadata based on weights assigned to each of the features enhancing the metadata.

6. The system of claim 2, wherein the fields include at least one of a location of the document, a type of document and an author of the document.

7. The system of claim 1, wherein the processor is further caused to assign a priority value to the features enhancing the metadata.

8. The system of claim 1, wherein the processor is further caused to:
compare one trained machine learning agent of a plurality of trained machine learning agents to one or more other trained machine learning agents of the plurality of trained machine learning agents to determine an overall mapping of the plurality of categories.

9. The system of claim 8, wherein the processor is further caused to:
compare a new document to the plurality of trained machine learning agents;
determine if the new document matches one or more of the categories represented by the plurality of trained machine learning agents; and
if the new document does not match one or more of the categories represented by the plurality of trained machine learning agents, create a new trained machine learning agent for a new category represented by the new document.

10. The system of claim 8, wherein the processor is further caused to;
compare one trained machine learning agent of the plurality of trained machine learning agents to a plurality of new documents; and
determine which new documents to the plurality of new documents best match the category represented by the one trained machine learning agent.

11. A method, comprising:
receiving, by a processor, a document including at least one of structured data, semi-structured data, and unstructured data,
wherein the structured data includes metadata about the document in a structured format, the semi-structured data includes content of the document in an unstructured format and metadata about the document in the structured format and the unstructured data includes the content of the document in the unstructured format and
wherein the content in the unstructured format includes one of natural language data and speech data;
receiving, by the processor, a trained machine learning agent that is configured to predict a category for classification data for a plurality of documents,
wherein the trained machine learning agent having been trained with training data including features enhancing the metadata in the structured format and the content in the unstructured format, and
wherein during training, the trained machine learning agent learns a set of parameters configured to discriminate among a plurality of categories;
analyzing, by the processor, the metadata in the structured format to generate features enhancing the metadata in the structured format,
wherein the features enhancing the metadata include a field, a value, and a combination of the field and the value evaluated to determine a probability value for each of the field, the value, and the combination of the field and the value for accurately defining the document;
producing, by the processor, the classification data for the document based on the features enhancing the metadata in the structured format and the content in the unstructured format;
providing, by the processor, the classification data to the trained machine learning agent, wherein the trained machine learning agent applies a transformation using learned parameter values to generate one or more predicted categories for the document; and
automatically classifying, by the processor, the document by associating the document with the predicted category and storing a classification record in memory.

12. The method of claim 11, wherein the content of the document in the unstructured format is used in determining the probability value.

13. The method of claim 11, wherein the features enhancing the metadata are evaluated from the metadata based on a continuum of a numerical value of the field in the metadata instead of the numerical value of the field itself.

14. The method of claim 11, wherein the features enhancing the metadata are evaluated from the metadata based on a proximity of each of the features enhancing the metadata to other features enhancing the metadata.

15. The method of claim 11, wherein the features enhancing the metadata are evaluated from the metadata based on weights assigned to each of the features enhancing the metadata.

16. A non-transitory, computer-readable medium comprising a set of instructions stored therein which when executed by a processor, causes the processor to:
receive a document including at least one of structured data, semi-structured data, and unstructured data,
wherein the structured data includes metadata about the document in a structured format, the semi-structured data includes content of the document in an unstructured format and metadata about the document in the structured format and the unstructured data includes the content of the document in the unstructured format and
wherein the content in the unstructured format includes one of natural language data and speech data;
receive a trained machine learning agent that is configured to predict a category for classification data for a plurality of documents,
wherein the trained machine learning agent having been trained with training data including features enhancing the metadata in the structured format and the content in the unstructured format, and
wherein during training, the trained machine learning agent learns a set of parameters configured to discriminate among a plurality of categories;
analyze the metadata in the structured format to generate features enhancing the metadata in the structured format,
wherein the features enhancing the metadata include a field, a value, and a combination of the field and the value evaluated to determine a probability value for each of the field, the value and the combination of the field and the value for accurately defining the document;
produce the classification data for the document based on the features enhancing the metadata in the structured format and the content in the unstructured format;
provide the classification data to the trained machine learning agent, wherein the trained machine learning agent applies a transformation using learned parameter values to generate one or more predicted categories for the document; and
automatically classify the document by associating the document with the predicted category and store a classification record in memory.

17. The non-transitory, computer-readable medium of claim 16, wherein the content of the document in the unstructured format is used in determining the probability value.

18. The non-transitory, computer-readable medium of claim 17, wherein the features enhancing the metadata are evaluated from the metadata based on a continuum of a numerical value of the field in the metadata instead of the numerical value of the field itself.

19. The non-transitory, computer-readable medium of claim 16, wherein the features enhancing the metadata are evaluated from the metadata based on a proximity of each of the features enhancing the metadata to other features enhancing the metadata.

20. The non-transitory, computer-readable medium of claim 16, wherein the features enhancing the metadata are evaluated from the metadata based on weights assigned to each of the features enhancing the metadata.
